(19) United States
(12) Patent Application Publication
(10) Pub. No.: US 2009/0222452 A1
(43) Pub. Date: Sep. 3, 2009

(54) Stateful Database Command Structure

(76) Inventors: Edward W. R. Bagg, Port Coquitlam (CA); Robert A. Taylor, Port Moody (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 12/039,311

(22) Filed: Feb. 28, 2008

(51) Int. Cl. G06F 15/16

(52) U.S. Cl. 707/10; 707/E17.032

(57) ABSTRACT

The intermediate stateful database includes a controller (an archiver) and a plurality of tables. The archiver receives commands from a centralized command console, receives a command update request from a remote device, generates a plurality of commands in response to the command update request, transmits the plurality of commands to the remote device, and receives a plurality of results corresponding to the plurality of commands from the remote device. The archiver receives the command information corresponding to the plurality of commands and result information corresponding to the plurality of results and distributes items of the command information to a plurality of tables in the intermediate stateful database. Command identification information and associated command/error table associations are loaded into the command identification (CID) table. Command sequencing, command results and associated command identification information is loaded into the command (CMD) table.

### BACKGROUND OF THE INVENTION

1. Field of the Invention

The present invention relates generally to providing a centralized communication point in a digital imaging device managing system and particularly to a system and a database that is a central communication point between a number of remote client devices, as well as a protocol that is utilized to communicate between the database, the centralized administration system, and the remote client devices.

2. Description of the Prior Art

Current methods for performing distributed command and control between remote clients and a central server sometimes require a remote client device to be in constant communication with the centralized administration system. In other systems, such as Microsoft and Symantec systems, a feature of auto updating takes place to update remote client devices from the centralized administration system. Systems like Microsoft and Symantec, however, do not include any command interpretation or prioritization capability.

Once the client for these organizations accepts the process, the update goes forward until the update is complete. In many cases, the client device must remain connected to the centralized administration server until the update is complete. The centralized administration server may be referred to as centralized command console. This ties up system resources and also requires tethering of the client device to a centralized administration server until all of the commands are completed.

### BRIEF DESCRIPTION OF THE DRAWINGS

FIG. 1 illustrates an overview block diagram and dataflow diagram of operation of a presentation system including the stateful database according to an embodiment of the invention;

FIG. 2 illustrates a more detailed view of a client device, a stateful database and a centralized command console according to an embodiment of the invention; and

FIG. 3 illustrates a stateful database and a number of tables with a stateful database according to an embodiment of the invention;

### DETAILED DESCRIPTION OF EMBODIMENTS OF THE INVENTION

A stateful database command structure allows a centralized database, i.e., the stateful database, to synchronize commands between a centralized administration server and a plurality of remote client devices. Commands may be scheduled at the centralized administration server for each of the remote clients and then downloaded to the stateful database. In addition, content may be downloaded through the stateful database. In addition, under certain operating conditions, content and/or commands may be downloaded to the remote devices directly from the centralized administration server. For example, there may be circumstances where immediate command lists are delivered in priority situations. Under these conditions, communication from the centralized administration server to the device may not be instantaneous. Illustratively, if remote devices are behind corporate firewalls that block outside requests, then the communication may not be instantaneous.

When the remote client next communicates with the stateful database, the remote client receives the downloaded command list. The remote client, in its communication with the stateful database, also uploads the status of previously transmitted commands to the stateful database. This stateful database command structure provides a more intelligent operation of distributing commands to a number of remote client devices from a centralized administration server while at the same time not tying up resources or tethering the client devices to the centralized administrative site until all of the commands are completed.

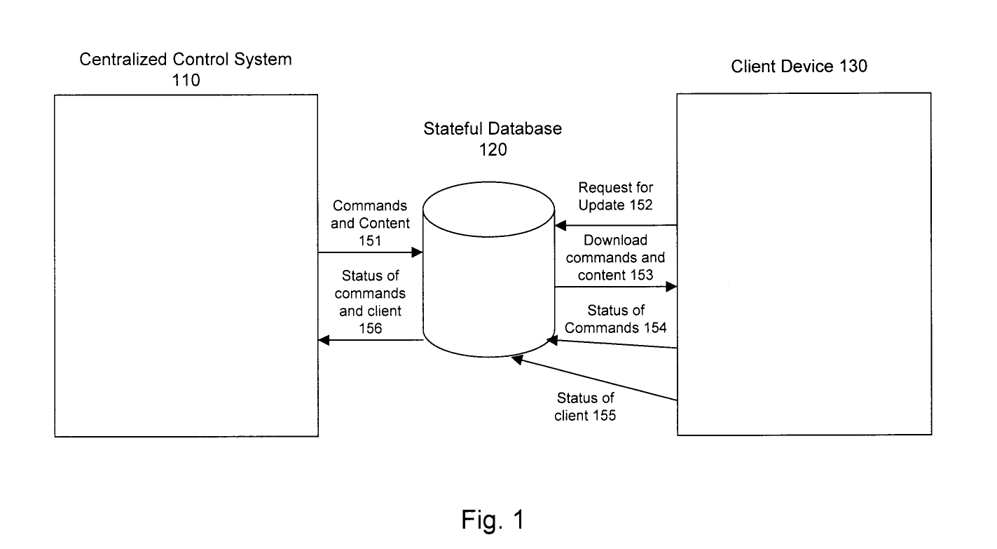

FIG. 1 illustrates an overview block diagram and dataflow diagram of operation of the system including the stateful database according to an embodiment of the invention. The system includes a centralized control system 110, a stateful database 120 and at least one client device 130. In most embodiments, the system includes a plurality of client devices, but for simplicity, only one client device is included in FIG. 1. Under certain operating conditions, interaction in the system may be started by transmitting 151 new, or modified, content as well as commands from the centralized control system 110 to the stateful database 120. Under certain operating conditions, only commands may be transmitted 151 from the centralized control system 110 to the stateful database 120. Depending upon the nature of the content and commands, the content and commands may be stored into tables within the stateful database 120. These tables are described below. The client device 130 may request 152 an update. Under certain operating conditions, the update request 152 may be used to request updated content. Under other operating conditions, the update request 152 from the client device may be to request updated commands or both updated content and updated commands.

In response to the update request 152, the stateful database 120 may download 153 the new or modified content (and/or) commands to the client device 130 that requested the update. Under certain operating conditions, the downloading of content and commands may occur at the same time. Under other operating conditions, the downloading of the commands may occur first and then the downloading of content may be scheduled for a different time that is more convenient for the operation of the remote client device 130. Under certain operating conditions, the content may be downloaded first and then the downloading of commands may occur or, alternatively, may be scheduled for a later time. After the content and/or the commands have been downloaded to the client device 130, the client device 130 may transmit 154 command status for each of the commands that have been downloaded to the stateful database 120 (or for command statuses that have changed since the last update). The remote client device 130 may also generate and transmit 155 reporting information regarding the remote client device 130, i.e., performance statistics, as well as generating operating condition information regarding the client device 130, e.g., lamp usage, diagnostic information, power-on hours, etc. This information may be transmitted to the stateful database 120.

The stateful database 120 receives the command status information (and, under certain operating conditions, the reporting information) from the remote client device 130 and transfers 156 this information to the centralized control system 110 to update the status of commands in a command manager which is located in the centralized control system 110. The command manager may manage all of the commands for the digital information system. Under certain operating conditions, the command manager in the centralized control system 110 may request the stateful database 120 to provide a status of commands for the plurality of remote client devices 130

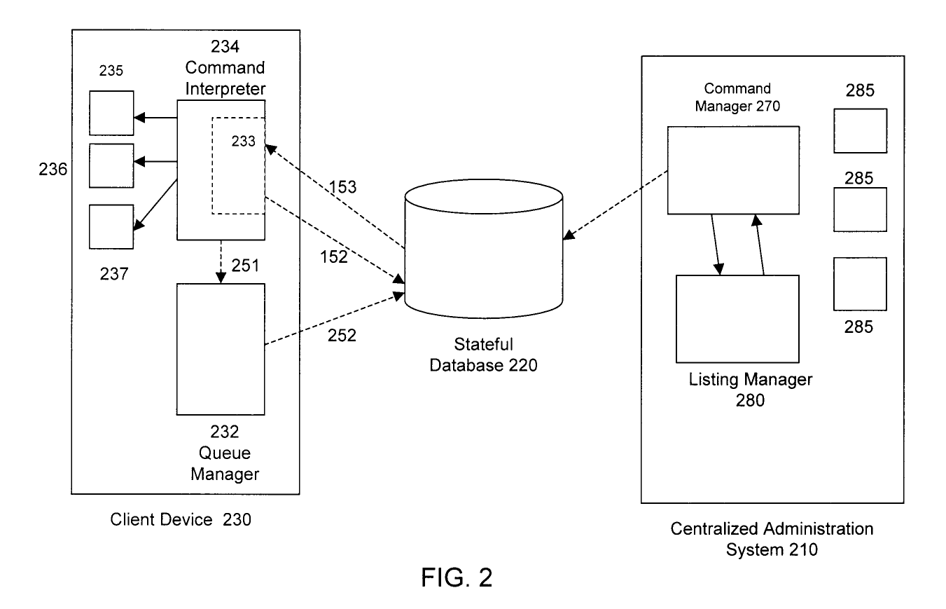

FIG. 2 illustrates a more detailed view of a remote client device 230, a stateful database 220 and a centralized command server 210 according to an embodiment of the invention.

A client device 230 may includes a command interpreter 234, a queue manager 232, and a plurality of functions 235, 236, and 237. The command interpreter 234 provides management of all commands that have been transferred from the command console 210 through the stateful database 220 to the remote client device 230. The plurality of commands may be acquired at the remote client device 230 during communication bursts with the stateful database 220. The command interpreter 234 receives the commands, schedules the commands for execution and manages their activities until a result occurs. This result could be completion, an error occurring, or a request for additional information. The commands interpreter 234 also executes command, logs the results of the commands being executed, and addresses priority issues within the commands.

Operation of the client devices in the digital marketing system is as follows. The client device 230 requests updates of commands from the stateful database 220. The client device 230 communicates with the stateful database 220 to request 152 (see FIG. 1) an updated listed of commands that the stateful database 220 has for the particular client device 230. Under certain operating conditions, the update request 152 is a simple database query with parameters that uniquely identify the particular client device 230 to the stateful database 220. The stateful database 220 generates a list of commands in response to the query and transmits 153 the list of commands to the requesting client device 230. New or modified content files may also be transmitted to the client device 230. The list of commands are then sent to the command interpreter 234. The command interpreter 234 deals with each command by executing the command. Results of the command execution are placed 251 in a communication queue 232. A communication module 233 may handle communications with the stateful database 220 in an embodiment of the invention. The queue manager 232 is used for the next routine communication with the stateful database 220. During this next communication, the stateful database 220 is updated with the command execution results transmitted 252 from the queue manager 232 to the stateful database 220. This results in the client device 230 being able to continue with its operational tasks by remaining untethered from the stateful database 220, which ensures necessary resources and ensures autonomous activities by the client device 230.

FIG. 2 also illustrates a command console according to an embodiment of the invention. The command console 210(also referred to as a centralized administration server) 210 includes a command manager 270, a listing manager 280, and a number of functions 295. The command console 210 does not communicate directly with the client devices 230. Instead, the command console 210 communicates with the command database 220 and the command database 220 communicates with the plurality of client devices 230.

In an initial part of the operation, content is created at the centralized command console 210 by an operator or is created by a third party and loaded into centralized command console 210. Similarly, commands and a command structure may be created at either a centralized command console 210 or by a third party and then entered into the centralized command console 210. The commands are then entered into the listing manager 280 which is located in the centralized command console 210. In response to a request (or on a periodic basis), the commands, command structures and/or content are then loaded into the command manager 270 in the centralized command console 210. The command manager 270 then transfers the commands and/or content to the stateful database 220 in response to a request, or alternatively, on a periodic basis.

The command console 210 may also request a list of previously issued commands from the command database 220. Under certain operating conditions, the command console 210 may send a filtered request, e.g., requesting updates on only commands issued in the last two days or only commands issued to client devices in one specific region. The command console 210 receives the requested command list from stateful database 220. For example, this may be an update on the status on all commands issued in the last two days. The command console 210 will translate the received updated command list into a presentable format. Illustratively, the updated command list may be transmitted to a browser that initiated the request in an HTML or XML format.

In the centralized command console 210, changes or alterations may be made to commands, e.g., deletions can be made, commands can be modified, commands can be added, parameters in commands may be made, etc. Under certain operating conditions, the command can be sent to a specific client, a group of clients, or all clients. Under some operating conditions, a command that was previously issued can be modified if the command has not been executed yet. Illustratively, the centralized command console 210 receives status of commands from the stateful database 220 and determines that a command issued one day previously has not yet been executed by the remote client device 230. The centralized command console 210 may then send an updated command to the stateful database 220 which can then transmit the updated command to the remote client device 230. Similarly, a command can be recalled (either from the stateful database 220 or from the remote client device 230) if it has been issued, but has not yet started executing. Under certain operating conditions, the command can only be deleted if the command is in the state of NEW. Under these operating conditions, the command may be in one of the following states: NEW, PENDING, COMPLETE, or FAILED. The centralized command console 210 can also send the list of commands to be presented on any display device.

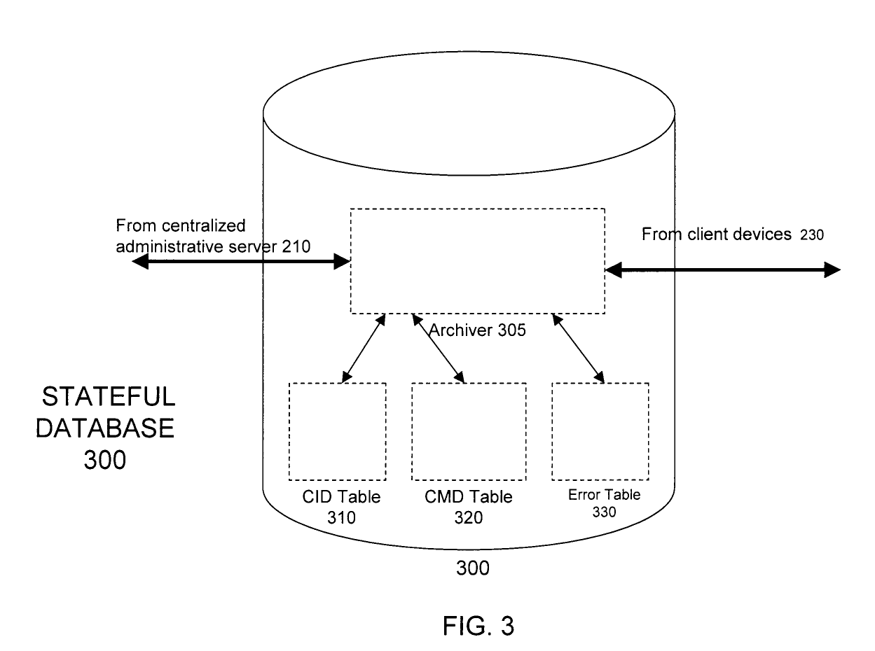

FIG. 3 illustrates a stateful database including a number of tables according to an embodiment of the invention. The stateful database 300 is a central part of the digital marketing system. The stateful database 300 is a centralized device that issues commands to client devices and takes status information from client devices and passes the status information to the central administrative server 210. The stateful database 220 includes an archiver 305, a command identifier table 310, a command table 320 and an error description table 330. The stateful database 300 may also include a number of additional tables.

In an embodiment of the invention, the archiver 305 handles each request coming into the stateful database 300. Illustratively, the archiver 305 receives the new or updated content and/or commands from the centralized server or command center 210. The archiver 305 also receives the request for updated content and/or commands from any of the plurality of remote client devices 230. The archiver 305 receives the command execution updates/status from each of plurality of remote client devices 230. The archiver then passes the command execution update/status to the centralized server or command center 210. In an embodiment of the invention, there is not an archiver 305 in the stateful database 300.

The archiver 305 also communicates with the command identifier (CID) table 310, the Command Table 320 and the Error Table 330. In an embodiment of the invention, new commands are developed from the centralized command or administrative server 210. This information is normalized into command IDs (CIDs), error responses, command sequencing information, and command results information. In an embodiment of the invention, the information is provided to the archiver 305. The archiver 305 takes the normalized information and fills the above tables in with the appropriate information provided. Illustratively, the CID Table 310 gets the Command ID and associated command and error table associations, the Command (CMD) Table 320 gets the command sequencing and command results information with associated CID information and the error table 330 gets the error responses information with the associated CID information.

The command identifier (CID) table 310 includes a plurality of entries. The command identifier table 310 is a table of unique IDs for commands. Each of the unique IDs point to specific commands in the command table 320. In an embodiment of the invention, an entry in the command identifier table includes a command identifier title, a command identifier description, and a command identifier structure.

The command identifier title is a short name for the command and may or may not be the keyword (e.g., LOAD, SAVE, etc.). The commend identifier description is a natural language version of the command. The command identifier structure is a format for the command that needs to be used when executing the command. In the Epson stateful database 300, there is no specific format for commands. The Epson stateful database command structure is flexible and command structures may be modified or changed easily. The commands may be added or deleted and can be customized based on the application executed by the digital marketing system. When the centralized server or command center 210 transmits the updated commands or command structure to the stateful database 300, new IDs are created that correspond to the new or modified commands. Under other operating conditions, the centralized command center 210 may create the new command identifiers.

The command identifier structure may include fields such as a unique identifier, a command identifier, a priority, a period of execution, a parameter list and an end command code. In addition, additional command structures include 1) a unique identifier, result field, status field, time of completion field, and a result code field; 2) a unique identifier and status update field; 3) a unique identifier and a time update field; 4) a unique identifier and a synchronize field; 5) a unique identifier and command delete request; 6) a unique identifier and a get file request; 7) unique identifier and a switch directories request; 8) a unique identifier and a get option identifier; and 9) a unique identifier and a send option identifier. The list below includes illustrative command identifier structures utilizing some of the above-identified command structures in the system employing the stateful database 300.

### Illustrative Commands Utilizing Command Structures

| COMMAND AND STRUCTURE | DESCRIPTION OF COMMAND |
|---|---|
| ADD <X><Y><Width><Height><Name> | This commands adds a touchable region at a |
| | specific location to the touch screen driver of the |
| | presentation device |
| ADDHOLE <X><Y><Width><Height><Name> | This commands adds a hole to a touch layer in |
| | the touch screen driver of the presentation |
| | device. |
| CONNECT <CommPort> | This command connects to a specific COMM |
| | port to transfer information utilizing the specific |
| | COMM port. |
| CREATE <FileType> | This commands creates a configuration file that |
| | is updateable though the Archiver. |
| DISPLAY <mediaFile><X><Y> | This command displays a media file on a screen |
| | of the presentation device at a location x, y. |
| FIND <value> NAME | This command finds a specified value in a |
| | generic list and identifies it as a node name |
| | within a file structure. Illustratively, this could |
| | be a node name in an XML file structure. |
| LOAD <configFile> | This command loads a configuration file (for a |
| | presentation device). |
| MUTE <ON\|OFF> | This command turns the A/V mute on or off on |
| | an Espon projector. |
| NEXT FILE | This command gets a next file in a presentation |
| | list. |
| NEXT PRESENTATION | This command gets a next presentation in a file |
| | list. |
| PULSEEVERY <period> | This commands sets a timer driver for a |
| | presentation device to go off every period. |
| PWR <ON\|OFF> | This command turns a presentation device on |
| | and off. |
| RESIZE <X><Y> <Width><Height> | This command resizes a displaying part of the |
| | driver for the presentation device in order to |
| | display the file in the presentation at a resized |
| | display dimension. |
| REMOVEALL | This command removes all touchable regions |
| | from the touch screen driver. |
| REQUEST | This command runs a predefined query on the |
| <requestNumber><Query><Param1\|Param2\|...> | stateful command database according to an |
| | embodiment of the invention. |
| SET ARCHIVERNAME <nameofArchiver> | This command sets the name of the archiver |
| | component |
| SET FILECHECK <ON\|OFF> | This command sets the default file rule for the |
| | file manager |
| SET FILECHECKEXCEPTION <ComponentID> | This command sets the component to be exempt |
| | from the default file check rule for the file |
| | manager |
| SET HIDE <ON\|OFF> | This command hides the displayed part of the |
| | driver to allow for the use of a Mask, video and |
| | or flash animation. |
| SET MASK <maskFile> | This command sets what file is used as the |
| | mask. |
| SET RETRY <ON\|OFF> | This command sets whether the driver attempts |
| | to retry a failed component. |

The updated commands and command structures are placed in the command identifier table 310 and the command table 320.

The command table 320 may include a number of entries. The command table 320 offers a breakdown of commands and how the commands are used. Each entry in the command table 320 includes a number of fields. The command table 320 includes a unique identifier, a component identifier (destination of command), a driver identifier (the driver that executes the command), a command identifier, a priority, a parameter list, a status, a repeat frequency, a time of creation, a time of execution, a time of completion, a result code and a creator. The command table 320 stores commands that have been (or are scheduled to be) sent to the remote devices 230 and keeps track of the parameters and status of the commands.

Under certain operating conditions, the commands utilized between the centralized administrative server 210, the stateful database 300 and the client devices 230 are database queries or database update queries. The results of these queries include the command structures that the centralized command console 210 and client devices 230 interpret in order to address the commands being issued.

The client queue structure may include a unique identifier, a command identifier, a time of execution, a command status, parameters utilized, results of command and an end command character. The time field may be an actual time or an updated time. The status field may include information, a completed status, or a failed status. In an embodiment of the invention, the client command queue structure outlines the structure of commands to be processed or alternatively, is the queue of commands to be processed.

The error description table 330 includes a plurality of entries. The error description table 330 is a modifiable table that associates error codes (e.g., numbers or unique identifiers) with commands and also with actual error descriptions (e.g., in a understandable language). The table is modifiable to allow modification of actual error descriptions without having to change the software code in the application. This is essential if the application is to be translated into other languages or if the actual error description needs to be changed to be more specific. In an embodiment of the invention, the error description table includes the unique identifier (UID), a code (e.g., error code), and a description (error description).

A number of embodiments of the invention have been described. Nevertheless, it will be understood that various modifications may be made without departing from the spirit and scope of the invention. For example, some of the steps described above may be order independent, and thus can be performed in an order different from that described. Accordingly, other embodiments are within the scope of the following claims.

1. A method for controlling a plurality of remote devices, comprising:
receiving, at an intermediate database, digital data from a centralized command console, the centralized command console being remote from the intermediate database;
storing said received data at the intermediate database;
receiving, at the intermediate database, a command list from the centralized command console;
queuing a plurality of commands from the command list in the intermediate database;
receiving an update command request from the remote device at the intermediate database; and
transmitting commands corresponding to the update command request to the remote device.

2. The method of claim 1, further including receiving, at the intermediate database, an update data request from the remote device and transmitting data in response to the update data request from the intermediate database to the remote device.

3. The method of claim 2, wherein in the transmitting of the commands and the transmitting of the data to the remote device occurs simultaneously.

4. A remote client device to communicate with an intermediate stateful database, comprising:
a communication module to request updated commands from an intermediate stateful database;
a command interpreter to receive transmitted commands corresponding to the request and to execute the received commands which generates results corresponding to the executed commands; and
a command queue manager to receive the results of the executed command and to place the results of the executed command into a queue, wherein the results from the command queue manager are transmitted from the command queue manager to the intermediate stateful database.

5. The remote client device of claim 4, wherein the results are transmitted to the intermediate stateful database on a scheduled basis.

6. The remote client device of claim 4, wherein the results are transmitted to the intermediate stateful database during a same communication session as when updated commands are transmitted to the remote client device from the intermediate stateful database.

7. A intermediate stateful database, comprising:
a controller to receive commands from a centralized command console, receive a command update request from a remote device, generate a plurality of commands in response to the command update request, transmit the plurality of commands to the remote device, and receive a plurality of results corresponding to the plurality of commands from the remote device; and
a plurality of tables to receive information corresponding to the plurality of commands and the plurality of results and to store the information.

8. The intermediate stateful database of claim 7, wherein the plurality of results are received from a queue manager in the remote device.

9. The intermediate stateful database of claim 7, wherein an archiver receives command from the centralized command console, transmits the command update request from the remote device, transmits the plurality of commands to the remote device and receives the plurality of results corresponding to the executed plurality of commands.

10. The intermediate stateful database of claim 9, wherein the archiver receives the command information and distributes items of the command information to a plurality of tables in the intermediate stateful database.

11. The intermediate stateful database of claim 10, wherein command identification information and associated command/error table associations are loaded into the command identification (CID) table.

12. The intermediate stateful database of claim 10, wherein command sequencing, command results and associated command identification information is loaded into the command (CMD) table.

13. The intermediate stateful database of claim 10, wherein error response information along with the associated command identification information is loaded into the error table.

14. The intermediate stateful database of claim 10, further including a command identifier table having a plurality of entries.

15. The intermediate stateful database of claim 14, wherein a number of the plurality of entries include a command identifier title, a command identifier description and a command identifier structure.

16. The intermediate stateful database of claim 10, further including a command table having a plurality of entries.

17. The intermediate stateful database of claim 16, wherein the plurality of entries each include a unique identifier, a component identifier, a priority, a parameter list, a status, a repeat frequency, a time of creation, a time of execution, a time of completion, a result code and a creator.

18. The intermediate stateful database of claim 10, further including an error table having a plurality of entries.

19. The intermediate stateful database of claim 18, wherein the plurality of entries include a unique identifier, an error code and an error description.
